(19) United States
(12) Patent Application Publication
(10) Pub. No.: US 2024/0306816 A1
(43) Pub. Date: Sep. 19, 2024

(54) SUPPORT ASSEMBLY FOR A PANEL

(71) Applicant: M3 Glass Technologies, Irving, TX (US)

(72) Inventors: Aaron Gwaltney, Richland Hills, TX (US); Erika Kelley, Richland Hills, TX (US)

(73) Assignee: M3 Glass Technologies, Irving, TX (US)

(21) Appl. No.: 18/603,914

(22) Filed: Mar. 13, 2024

Related U.S. Application Data
(60) Provisional application No. 63/452,731, filed on Mar. 17, 2023.

(51) Int. Cl. A47B 97/04; B43L 1/00; F16M 11/42

(52) U.S. Cl. CPC A47B 97/04; B43L 1/00; F16M 11/42

(57) ABSTRACT

A panel assembly including a panel and at least one base member for supporting the panel. The at least one base member is configured between a stored position and a use position. The assembly further includes a locking mechanism, the locking mechanism configured to secure the at least one base member to the panel in the use position.

### CROSS REFERENCE TO RELATED APPLICATION

This application claims priority to and the benefit of U.S. Provisional Patent Application No. 63/452,731 filed on Mar. 17, 2023, the contents of which are incorporated herein by reference in their entirety.

### TECHNICAL FIELD

This disclosure relates to mobile panel assemblies, and further mobile panel assemblies incorporating supports that can be packaged separately from the panels for ease of transport and shipping.

### BACKGROUND

Oftentimes, glass panel assemblies, including for example, mobile white boards that are supported on caster wheels or other similar supports, are transported to their destinations in wooden crates. In many instances, multiple panel assemblies are nested into a wooden crate for shipment. Before shipping, however, the base (or legs) is attached to the to the panel or frame that supports the panel. Padding and other flexible material such as foam and/or quilted layers can be added as a cushion between the panels to prevent or substantially reduce damage to the panels during transportation. This requires careful packing, increased time to pack, extra materials and expenses, and most importantly, if improperly packed, damage can occur.

### SUMMARY OF THE INVENTION

The present disclosure provides embodiments of a panel assembly in which the legs/supports can be shipped separately from the panels and once the panels arrive at their destinations for unpacking, the legs/supports can be secured to the panel.

In addition to or in lieu of the above discussion, the leg can be swiveled, pivoted, folded, and/or rotated relative to the frame from a stored position, whereby the legs are flush with the frame for storage and shipping, and an extended position, whereby the legs are pivoted, unfolded, swiveled and/or otherwise rotated outward from the panel to support the panel assembly on a surface for use.

### BRIEF DESCRIPTION OF THE DRAWINGS

The subject matter of the present disclosure is particularly pointed out and distinctly claimed in the concluding portion of the specification. A more complete understanding of the present disclosure, however, is best be obtained by referring to the detailed description and claims when considered in connection with the drawing figures, wherein like numerals denote like elements.

FIG. 1 illustrates a perspective view of a panel assembly with a pair of support legs secured to and supporting the panel.

FIG. 2 illustrates a front view of the panel assembly of FIG. 1.

FIG. 3A illustrates a side view of the panel assembly of FIG. 1.

FIG. 3B illustrates a detail partial exploded side view of the panel assembly of FIG. 1.

FIG. 3C illustrates a detail view an alternative configuration of the panel assembly of FIG. 1.

FIGS. 4A and 4B are illustrations of the panel assembly in a stored position.

FIGS. 5A and 5B are illustrations of the panel assembly in a use position.

FIG. 6 illustrates a detail exploded view of the legs and a frame of a panel in which an embodiment of a locking mechanism is employed to advantage.

FIG. 7 illustrates a section view of the locking mechanism taken along the line 7-7 of FIG. 6.

FIG. 8 illustrates a detail exploded view of the leg and portion of the frame of a panel.

### DETAILED DESCRIPTION

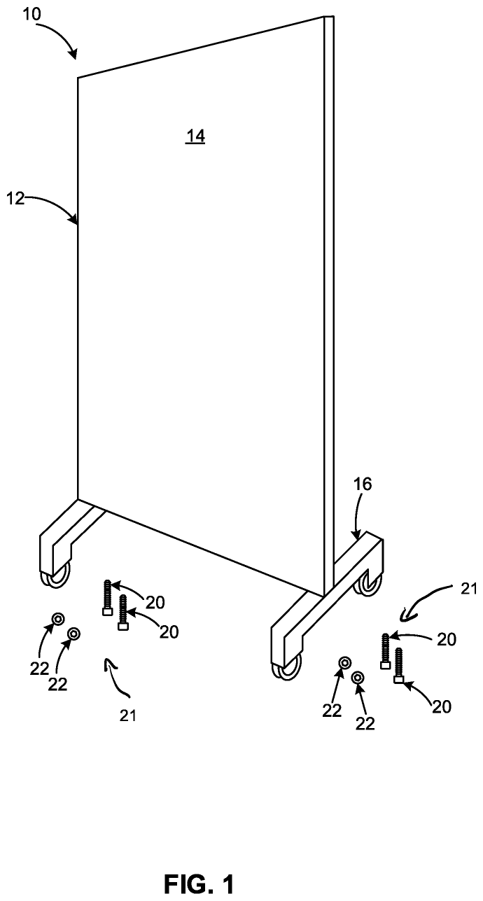

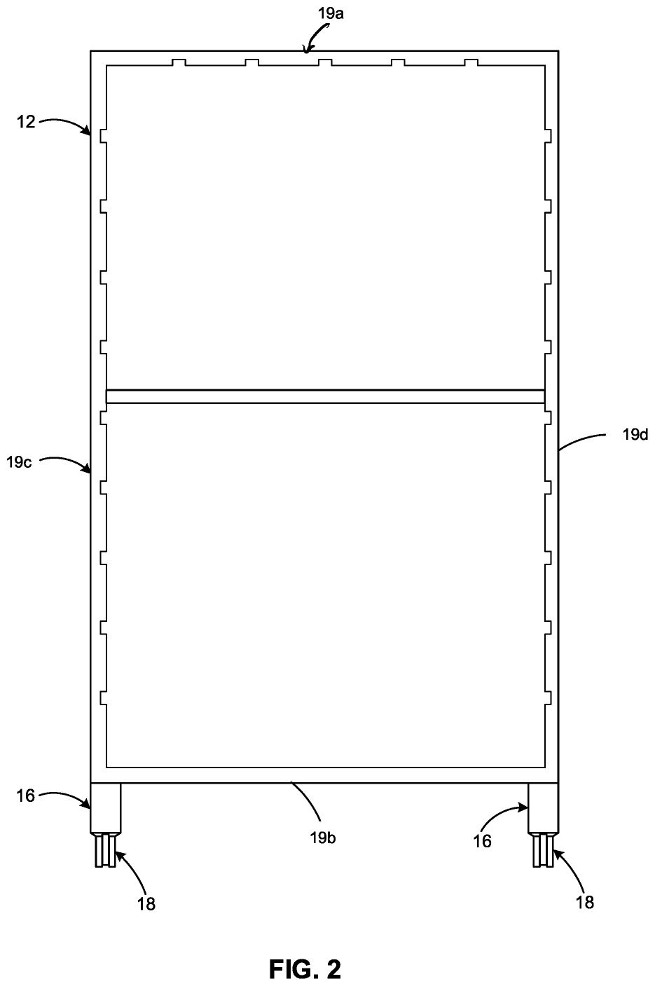

FIGS. 1-3C are illustrations of a panel assembly 10 in which a frame 12 employs removable and/or adjustable support assembly consisting of one or more base members/legs 16 to advantage. Referring specifically to FIGS. 1 and 2, the frame assembly 10 includes a panel 14 that can be formed of glass or any other rigid surface to, among other things, allow a user to write or display items directly thereon. According to some embodiments, the panel 14 can be formed of a glass or other similar material to act as a dry-erase board; however, other configurations are also useful (i.e., chalk-board, mirror, corkboard, or any other vertically supported structure). According to embodiments disclosed herein, the removable/adjustable legs 16, as explained in greater detail below, are configured to reduce freight costs on single and multiple unit shipments, allow for shipping to a broader customer base, and eliminate excessive use of lumber and other materials for crating product. For example, when it is desired to ship the panel assembly 10, the legs 14 are shipped completely detached from the panel 14 so that multiple panels can be stacked or otherwise adjacently positioned without legs protruding or otherwise extending outward in a direction generally normal to the panel 14, which would require spacing or special orienting between the panels 14. In other embodiments, the legs 16 may be movable and positioned between a stored position, where they are folded or do not otherwise extend outwardly in a direction away from the panel 14, and a use position, where the legs 16 are positioned to support the panel assembly 10 upright for use.

In the embodiment illustrated in FIGS. 1-3C, the panel 14 is supported by a frame assembly 12, which is secured to the legs 16. Referring specifically to FIG. 2, the frame 12 is formed having a top frame segment 19a, a bottom frame segment 19b, and side segments 19c and 19d. It should be understood that frame assembly 12 may be otherwise configured. For example, the panel 14 may be supported by only bottom frame segment 19b or only side segments 19c and/or 19d. In such a configuration, the legs 15 would be secured to the bottom frame segments 19a and/or side segments 19c/19d, as applicable. In other embodiments, the panel 14 can be a frameless panel (i.e., a panel 14 that is not supported by any frame member) and is otherwise directly coupled to the legs 16.

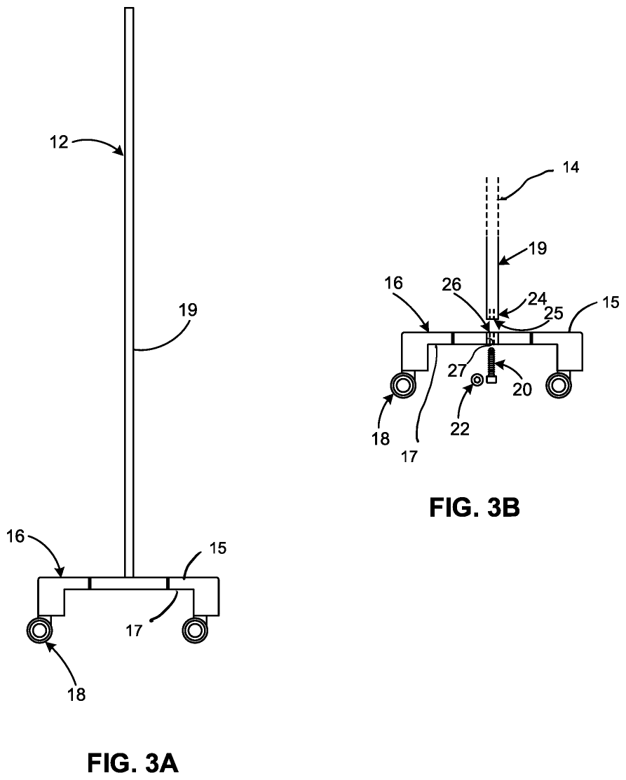

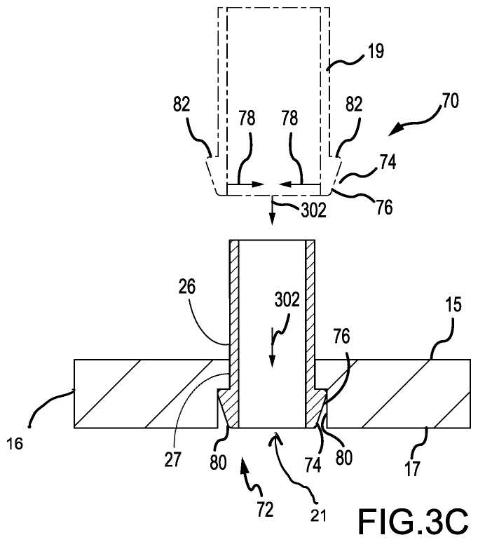

In the embodiment illustrated specifically in FIGS. 3B and 3C, each removable leg 16 is formed having a top surface 15 and a bottom surface 17 and an opening 26 extending therebetween for locking and otherwise securing the panel 14 to the leg 16. The leg 16 may optionally include wheels, such as caster wheels 18 secured thereto support and provide mobility to the panel assembly 10. It should be understood that legs 16 may be otherwise configured. For example, legs 16 can include planar supports for resting on a flat surface (i.e., supporting the panel 14 on the ground or other surface without the use of caster wheels).

According to some embodiments, the legs 16 are attached to the frame assembly 12 and/or directly to the panel 14 via a locking mechanism 21. In the embodiment illustrated in FIG. 3B, for example, the locking mechanism 21 includes a threaded bolt 20 for threadingly securing the panel 14 to the legs 16. As described below, the locking mechanism 21 can be, in addition to or in lieu of a threaded bolt 20, an adhesive, a magnet, a cotter pin, a friction fit or any other type of locking configuration. Regardless of the type of locking mechanism 21, the locking mechanism 21 can be used to facilitate a quick-connect assembly by coupling the legs 16 to the frame 12 or panel 14 after delivery to the destination.

Referring specifically to FIG. 3C, the locking mechanism 21 includes a snap-fit configuration for securing the legs 16 to the frame 12 and/or panel 14. In the embodiment illustrated in FIG. 3C, the locking mechanism 21 includes a snap-fit tongue and groove connection 72. For example, in the embodiment illustrated in FIG. 3C, the frame 12 includes a flexible extension member or tongue 74 having an outer surface 76 that is configured to slideably engage the sidewall 27 of the opening 26 when inserted therein. During installation, when the extension member 74 is inserted into the opening 26 in the direction of arrow 302, the outer surface 76 of the flexible extension member 74 engages the sidewall 27 and inwardly deforms the flexible extension member 74 in the direction of arrows 78 until the extension member/tongue 74 is disposed within a corresponding groove 80 in the legs 16. Once inside the groove 80, the flexible extension member 74 returns to its original static position such that an upper surface 82 of the extension member 74 engages the groove 80 to lock the frame 12 and/or panel 14 to the leg 16.

While FIG. 3C illustrates a flexible extension member 74 extending from the frame 12 and/or panel 14, it should be understood that the flexible extension member 74 may be disposed on and otherwise extend from the leg 16 and the groove 80 may be disposed in the frame 12 or directly in the panel 14. It should be understood that the frame 12 and/or panel 14 may be otherwise secured together, such as frictional engagement therebetween.

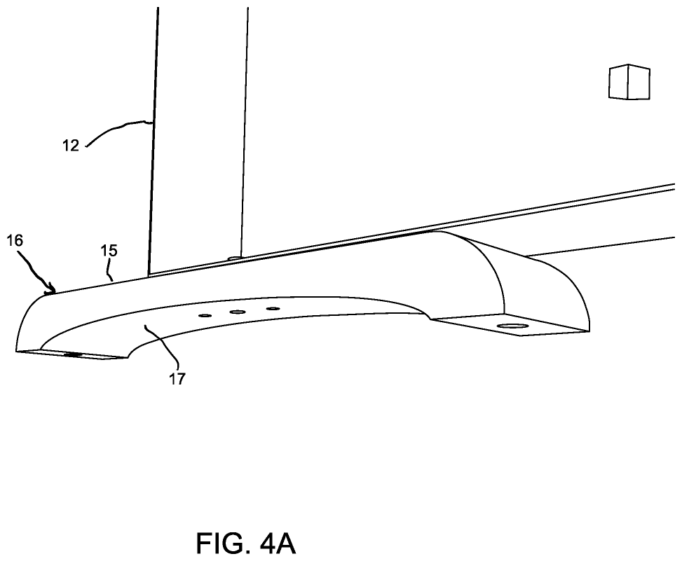

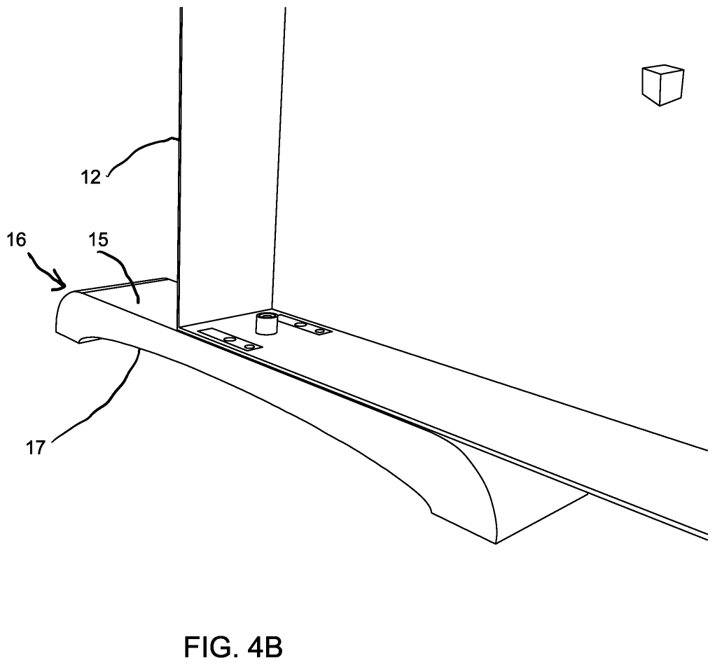

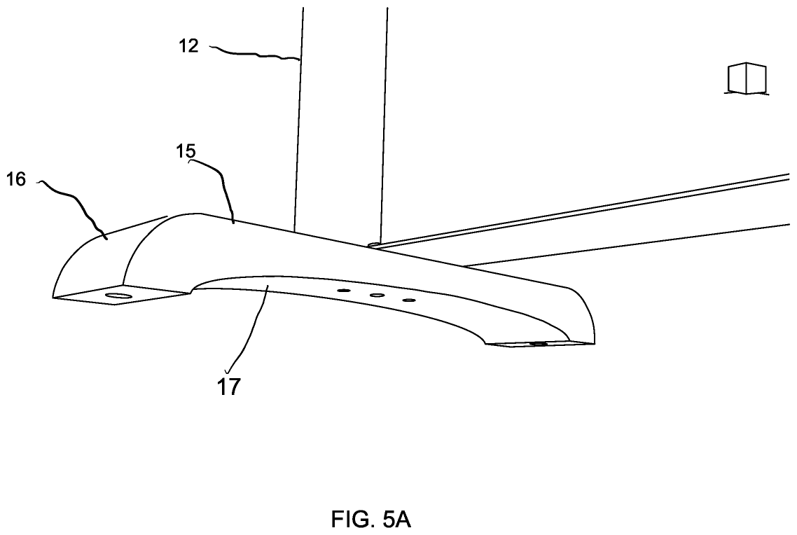

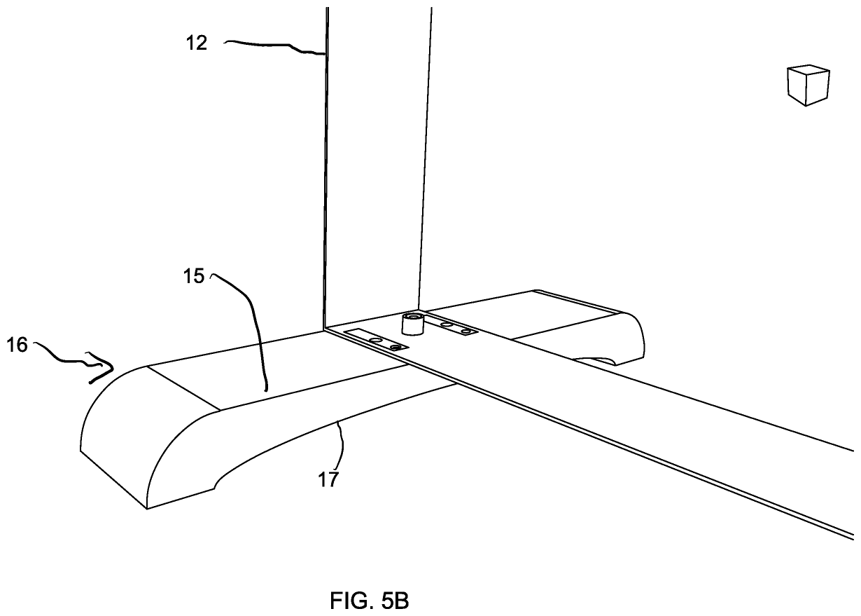

According to some embodiments and as previously mentioned, the legs can be positioned between the stored position (FIGS. 4A and 4B), when the legs are positioned for shipping and storage, and a use position (FIGS. 5A and 5B), when the legs 16 are positioned to support the panel assembly 10 upright for use.

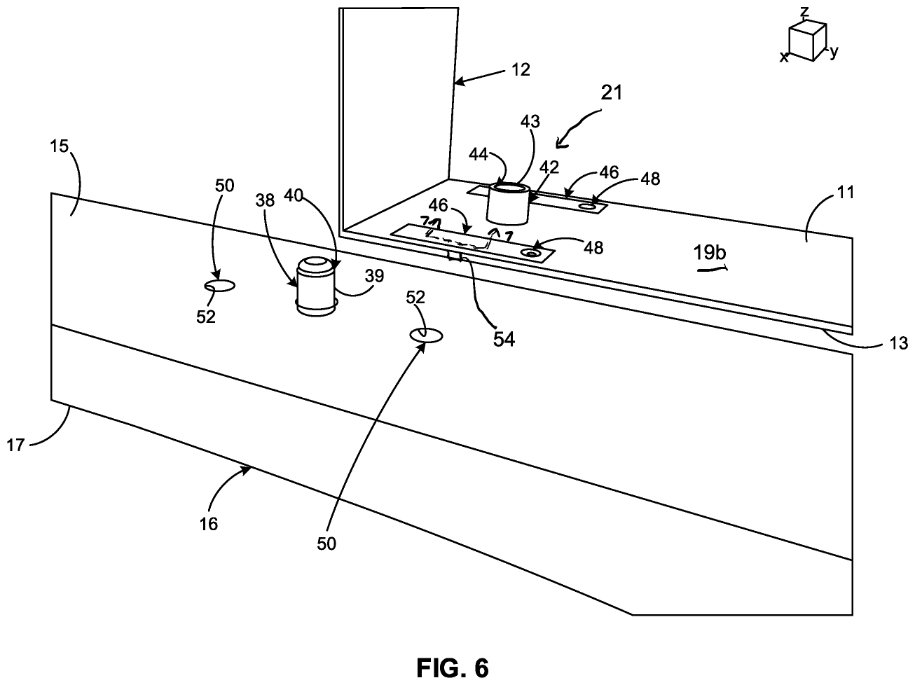

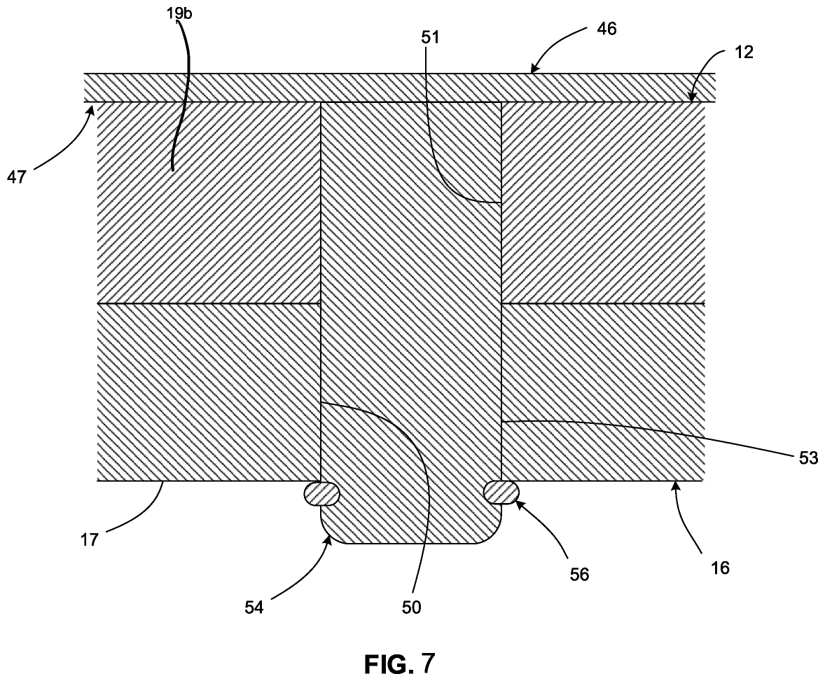

Referring specifically to FIGS. 6 and 7, an embodiment of a locking mechanism 21 is employed to advantaged. In use, the legs 16, once connected to the frame 12 and/or panel 14, are operable to swivel to the use (and locked) position to prevent and/or otherwise substantially resist separation therefrom. As illustrated, each leg 16 is formed having the top surface 15, a bottom surface 17 and a mounting stem 38 (or a base post or a detention pin) extending from a top surface 15. The frame 12 includes a hollow protrusion 42 having an opening 43 with an inner surface 44 extending from the top surface 11. The mounting stem 38 is sized to extend through the opening 43 so as to be received within the protrusion 42. As illustrated, the mounting stem 38 includes an outer surface 39 sized to fit within the opening 43 and beyond a top edge of the protrusion 42 of the frame 12 so that it can receive a snap ring 40 or other locking mechanism to secure the frame 12 to the leg 16 to prevent separation thereof. It should be understood, however, that in addition to or in lieu of to the snap ring connection 40, other methods to secure the base 16 and the frame 12 together can be used, such as a threaded bolt/nut, an adhesive, a magnet, a cotter pin, a friction fit, and the like.

With continued reference to FIGS. 6 and 7, the bottom frame segment 19b includes one or more tabs or spring members 46 coupled thereto via connectors 48. Each tab member 46 includes a mounting stem 54 (or frame post, or detention pin) extending from a bottom surface 47 of the tab member 46. The connector 48 securely couples the tab member 46 to the top surface 11 of the frame 12, which can be a nut and bolt connection, a snap ring connection, an adhesive, a magnet, a cotter pin, a friction fit, and the like.

As illustrated in FIG. 7, the leg 16 includes one or more openings 50 extending from the top surface 15 to the bottom surface 17. As illustrated, the mounting stem 54 extends into, and in some embodiments, through so as to extend beyond the bottom surface 17. In the embodiment illustrated in FIGS. 7, a snap ring 56 can be used to secure the frame 12 to the leg 16. It should be understood, however, that other means of securing can be used, such as a threaded bolt/nut, an adhesive, a magnet, a cotter pin, a friction fit, and the like.

In some embodiments, the frame 12 can rotate or otherwise swivel relative to the legs 16 from the stored position (FIGS. 4A and 4B) to the use position (FIGS. 5A and 5B) such that the spring tabs of the locking mechanism 21 deflect away from the top surface 15 as a result of the posts 54 sliding along the top surface 15 of the leg 16 until the post 54 is aligned with the opening 50. Once aligned, the spring energy generated by the locking spring tabs causes the post 54 to be inserted within the opening 50. Put another way, biasing of the spring tabs 46 occurs when the leg 16 rotates (along with the coupled or integrally formed mounting stem 38) around a longitudinal axis of the opening 43 of the protrusion 42. In some embodiments, the wall of the opening 43 of the protrusion 42 rotates around a longitudinal axis of the mounting stem 38 thereby biasing the spring tabs 46 due to the frame posts 54 being in contact with the top surface 15 of the base 16. The biasing continues during rotation until the post 54 is aligned with and inserted into the opening 50. It should be understood that the frame 12 may include a different biasing mechanism or not having such biasing mechanism at all. For example, the frame posts 54 can be coupled to the bottom surface 13 of the bottom portion 21 of the frame 12 via welding, brazing, adhesive, riveting, threaded bolt/nut connection, and/or integrally formed with the frame 12.

FIGS. 6-7 illustrate two frame posts 54 (and two spring tabs 46) corresponding to two base openings 50 to removably couple the frame 12 to the legs 16. However, it should be understood that the frame 12 may include any number of the frame posts 54 (for example, one frame post, three frame posts, etc.), the corresponding number of the spring tabs 46, and/or the corresponding number of the base openings 50.

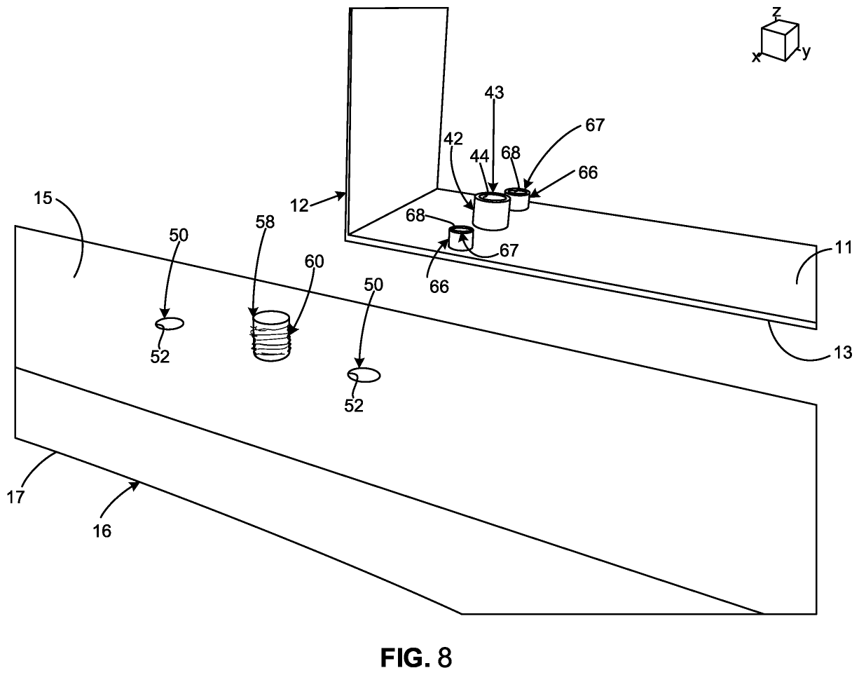

Referring now to FIG. 8, a detail exploded view of removable legs configured to be threadedly secured to a frame 12. As illustrated, the swivel leg 16 includes a mounting stem 58 (or base post) extending from a top surface 15 of the base 16. The frame 12 includes a protrusion 42 having an opening 43 with an inner surface 44. As discussed in greater detail below, the opening 43 is sized to receive and otherwise engage with the mounting stem 58.

In some embodiments, the openings 50 of the removable leg 16 and/or openings 67 in one or more protrusions 66 of the frame 12 are formed having a sidewall (e.g., a sidewall 52 and sidewall 68 of the openings 50 and 67, respectively). In some embodiments, a portion of the sidewall 67 includes threads such that, as explained in greater detail below, bolts (not shown) can threadingly engage the threaded portion of the sidewalls 67 of the openings 68 in order to securely fasten the frame 12 to the removable leg 16.

In some embodiments, the opening 43 in the protrusion 42 of the frame 12 is formed having a sidewall, a portion of which includes a threaded portion such that, as explained in greater detail below, corresponding threading on the outer surface 60 of the stem 58 can threadingly engage the threaded portion of the inner surface 44 of the opening 42 in order to securely fasten the frame 12 to the removable leg 16.

In some embodiments, to secure the frame 12 to the base 16, the base 16 can rotate (along with the coupled or integrally formed mounting stem 58) around a longitudinal axis of the opening 43 of the protrusion 42. In some embodiments, the opening 43 of the protrusion 42 can rotate around a longitudinal axis of the mounting stem 58 of the base 16. The mounting stem 58 includes an outer surface 60 that can be threadingly engaged with the threaded inner surface 44 of the opening 43 of the frame protrusion 42 to secure the frame 12 to the removable base 16. It should be understood, however, that other means of securing can be used, such as a snap ring, an adhesive, a magnet, a cotter pin, a friction fit, and the like.

FIG. 8 illustrates two protrusions 66 corresponding to two base openings 50, to removably couple the frame 12 to the legs 16. However, it should be understood that the frame 12 may include any number of the frame protrusions 66 (for example, one frame protrusion, three frame protrusions, etc.) and the corresponding number of the base openings 50.

In some embodiments, a method of modular packaging and/or transportation can be employed to advantage. Typically, the panel assemblies are transported in wooden crates such that up to five panel assemblies can be nested into one wooden crate. Before shipping, the base (or legs) are attached to the to the frame (that is attached to the panel). The padding of the flexible material such as foam and/or quilted layers and the like can be added as a cushion between the panels to prevent or substantially reduce damage to the panels during transportation.

The present disclosure provides description of the embodiments where the legs 16 can be, for example, removed from the frame 12 (that can be removably coupled to the modular panel 14) or swiveled inside to save the space within the shipping crate. For example, the frame 12 can be detached from the legs 16 that can be shipped separately from the frame 12 coupled to the panel 14 or in the same wooden crate. Upon arrival to a user's destination, the panel assembly 10 can be assembled by coupling the frame 12 to the legs 16 as described in the present disclosure.

As described above, alternatively or optionally, the legs 16 can be swiveled, pivoted, folded, rotated as to the frame 12, lockable with a detent, a snap ring, an adhesive, a magnet, a cotter pin, a friction fit, or the like. In some embodiments, when the legs 16 are removed or turned inside toward the frame such that the side profile occupies less space, it is possible to accommodate a greater number of the panel assemblies within each shipping crate, thus achieving the reduced cost of transportation.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments and it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A panel assembly, the panel assembly comprising:
a panel,
at least one base member for supporting the panel, the at least one base member configured between a stored position and a use position; and
a locking mechanism, the locking mechanism configured to secure the at least one base member to the panel in the use position.

2. The panel assembly of claim 1, wherein when at least one base member is in the use position, the at least on base member is configured to support the panel in an upright position, and when in the stored position, the at least one base member is configured to enable stacking of a plurality of panels during transport without contacting an adjacent panel.

3. The panel assembly of claim 2, wherein the legs are operable to swivel between the stored position and the use position.

4. The panel assembly of claim 2, wherein when the at least one base member is in the stored position, the at least one base member is detached from the panel.

5. The panel assembly of claim 1, further comprising a frame assembly disposed around the panel, the frame assembly having a top frame segment disposed along a top edge of the panel, a bottom frame segment disposed along a bottom edge of the panel, and a pair of side segments disposed along a respective side edge of the panel.

6. The panel assembly of claim 1, wherein the at least one base member is removably secured to the bottom frame segment.

7. The panel assembly of claim 1, wherein the locking mechanism comprises a threaded bolt for threadingly securing the at last one base member to the panel.

8. The panel assembly of claim 1, wherein the locking mechanism comprises at least one of an adhesive, a magnet, a cotter pin, or a friction fit.

9. The panel assembly of claim 1, wherein the locking mechanism includes a spring member disposed on the bottom frame member, the spring member biased to secure the at least one base member in a use position for supporting the panel in an upright position.

10. The locking mechanism of claim 9, wherein the spring member includes a post extending therefrom, the post configured to be disposed within an opening in the at least one base member in the use position to secure the at least one base member in the use position.

11. The panel assembly of claim 1, wherein the pair of base members comprise caster wheels secured thereto.
